(19) United States
(12) Patent Application Publication
(10) Pub. No.: US 2009/0291166 A1
(43) Pub. Date: Nov. 26, 2009

(54) METHOD FOR PRODUCING ICE CREAM

(75) Inventors: Don Higgins, Franklinton, NC (US); Thomas Lykke Soerensen, Alleroed (DK); Tine Muxoll Fatum, Alleroed (DK); Per Munk Nielsen, Alleroed (DK); Helle Skov Guldager, Vedbaek (DK)

Correspondence Address: NOVOZYMES NORTH AMERICA, INC., 500 FIFTH AVENUE, SUITE 1600, NEW YORK, NY, 10110, US

(73) Assignees: Novozymes A/S, Bagsvaerd (DK); Chr. Hansen A/S, Denmark (DK)

(21) Appl. No.: 12/295,035

(22) PCT Filed: Mar. 30, 2007
(86) PCT No.: PCT/EP2007/053114

§ 371 Date: Oct. 6, 2008

Related U.S. Application Data
(60) Provisional application No. 60/788,762, filed on Apr. 3, 2006.

(51) Int. Cl. A23G 9/00; A23L 1/20

(52) U.S. Cl. 426/35; 426/46; 426/7; 426/565

(57) ABSTRACT

The present invention relates to a method for producing ice cream with a phospholipase.

### TECHNICAL FIELD

The present invention relates to a method for producing ice cream with a phospholipase.

### BACKGROUND OF THE INVENTION

Ice cream is usually produced by freezing an ice cream mix, often comprising dairy ingredients, and usually also comprising additional components, including components that impart a desired flavour to the ice cream, e.g. fruit, nuts and chocolate. For consumer acceptance of ice cream properties such as melting stability, absence of crystals, flavour and taste are important. Traditionally egg yolk has often been used to improve the stability of ice cream and to reduce the effect of ice crystals. In industrially produced ice cream emulsifiers, e.g. mono- and diglycerides, and stabilisers, e.g. locust bean gum, are usually used to achieve the same effects and to improve stability of the ice cream to melting. WO 2004/064537 A2 discloses a method for in-situ preparation of an emulsifier in a foodstuff by use of a lipid acyltransferase without substantial increase in the free fatty acid content of the foodstuff.

### SUMMARY OF THE INVENTION

The inventors have found that treating one or more ice cream mix ingredients with a phospholipase and producing an ice cream mix from the treated ingredient, results in an ice cream mix with improved properties when used to produce ice cream. E.g. taste, texture and melting stability of the ice cream may be improved. The treatment may also reduce the need for addition of emulsifiers and/or stabilisers. Accordingly, the invention relates to a method for producing an ice cream mix comprising: a) treating one or more ice cream mix ingredients with a phospholipase under conditions sufficient to result in hydrolysis of at least 10% (weight/weight) of the phosphatidylcholine and/or 10% (weight/weight) of the phosphoethanolamine present in said one or more ingredients; and b) producing an ice cream mix with the one or more ice cream mix ingredients treated in step a); wherein step a) is conducted before, after or during step b). In further aspects the invention relates to a method for producing ice cream, use of an enzyme composition comprising a phospholipase and free from acyltransferase activity for producing an ice cream product, and to an ice cream product obtainable by the method of the invention.

### DETAILED DESCRIPTION OF THE INVENTION

### Ice Cream

Ice cream is a food product produced by freezing an ice cream mix. An ice cream mix is a mixture of one or more ingredients suitable for human consumption and suitable to be frozen to produce an edible frozen ice cream. Traditionally, an ice cream mix will comprise one or more dairy ingredients, but ice cream may also be produced purely from non-dairy ingredients, e.g. to be suitable for consumption by persons allergic to dairy ingredients or people that for other reasons wish to avoid dairy ingredients.

A dairy ingredient is an ingredient derived from or produced from milk. Examples of dairy ingredients are cream; dried cream; anhydrous milk fat; butter; butter oil; milk; concentrated milk; evaporated milk; sweetened condensed milk; dried milk; skim milk; concentrated skim milk; evaporated skim milk; condensed skim milk; sweetened condensed skim milk; sweetened condensed part-skim milk; non-fat dry milk; sweet cream buttermilk; condensed sweet cream buttermilk; dried sweet cream buttermilk; skim milk, that may be concentrated, and from which part or all of the lactose has been removed; whey and modified whey products (e.g., reduced lactose whey, reduced minerals whey, whey protein concentrate, and whey protein isolate); caseinates (e.g. ammonium caseinate, calcium caseinate, potassium caseinate, and sodium caseinate); hydrolysed milk protein, e.g. milk protein hydrolysed by acid hydrolysis or by use of a proteolytic enzyme; and total milk protein produced by heating the milk followed by coagulation of the protein by acid or rennet.

Ice cream may comprise non-dairy ingredients, e.g. eggs, egg derived ingredients, e.g. egg yolk; sugar, e.g. in the form of glucose, corn syrup based sweeteners, fructose, sucrose, invert sugar, polydextrose, or any mixture thereof; sugar alcohols, e.g. xylitol, lactitol or sorbitol; artificial sweetener, e.g. saccharin, cyclamate, aspartame, acesulfame, sucralose, and/or tagatose; acid, e.g. citric acid; flavour agents; colorants; syrups; vanilla; fruit; fruit juice; berries; nuts; almonds; caramel; cocoa; chocolate; stabilisers, e.g. gelatine, carboxymethyl cellulose, microcrystalline cellulose, galactomannans, pectin, carageenan, alginate, xanthan gum, agar, guar gum, or locust bean gum; emulsifiers, e.g. lecithin, mono- and/or diglycerides, or polyoxyethylene sorbitan fatty esters (polysorbates, e.g. polysorbate 80 (polyethylene sorbitan monooleate)); water; vegetable oils and fats, e.g. soy or safflower oil; soy milk; soy protein isolate; and/or soy protein concentrate.

In one embodiment of the invention ice cream is soy ice cream produced mainly or completely from soy derived ingredients. Soy derived ingredients to be used in soy ice cream may e.g. be soy oil, soy milk, soy lecithin, soy protein, soy protein isolate, and/or soy protein concentrate. Soy ice cream may comprise non-soy ingredients, e.g. vegetable oil such as safflower oil, or other ingredients mentioned herein as ingredients of ice cream. In one embodiment of the invention soy ice cream does not comprise a dairy ingredient.

An ice cream mix will usually comprise between 0.2% and 25% fat (weight/weight) depending on the type of ice cream. Ice cream according to the invention includes low-fat ice cream, sorbet sherbet, ice milk, and the like. In one embodiment of the invention an ice cream mix comprises more than 0.5% fat (weight/weight), such as more than 2%, more than 5% or more than 9% fat. Additionally, an ice cream mix based on dairy ingredients usually comprises between 1% and 20% non-fat milk solids (weight/weight), such as between 2% and 15%, or between 8% and 15% non-fat milk solids. An ice cream mix will usually also comprise non-milk solids, such as e.g. sugars, and the amount of total solids will usually be between 15% and 60% (weight/weight), such as between 20 and 50%, or between 25 and 45%. When sucrose and/or corn syrup sweetener is used to impart sweetness on the ice cream, these will usually account for between 5% and 40% (weight/weight) of the ice cream mix, such as between 10% and 35%, or between 15% and 25%. If artificial sweeteners are used, the amount of sugars, e.g. sucrose and corn syrup sweeteners, may be lower than indicated above, or they may be completely absent. Sucrose and/or corn syrup sweeteners may also be substituted by other sugars, e.g. other sugars mentioned herein as ingredients of ice cream. Ice cream according to the invention also includes frozen yoghurt. Frozen yoghurt may e.g. be produced by fermenting ingredients of the ice cream mix, e.g. skim milk optionally combined with other milk solids, with a yoghurt culture before mixing with the other ingredients of the ice cream mix.

Soy ice cream may e.g. be produced from soy milk, preferably high solids content soy milk, soy protein isolate, soy protein concentrate, soy lecithin, and/or vegetable oil, e.g. soy oil or safflower oil. Additionally it may contain sweetener, stabilizers, emulsifiers, various flavouring or fruits, and salt, and/or other ingredients mentioned herein. Soymilk for ice cream may preferably contain at least 10.5% solids, more preferable 11-12%. Roughly 78% solids in soymilk are usually non-fat solids. Soymilk made from whole soy beans may be preferred. The typical fat level in soy ice cream may be around 12% and achieved by addition of refined vegetable oil (e.g. soy or safflower). The sweetening of the ice cream can be done by addition of sucrose, honey, dextrose, corn syrup like high fructose corn syrup, or any other sweetener ingredient mentioned herein. Stabilizers may be used to provide a creamier texture and more body, retard or reduce crystallization growth, impart smooth melt down, and prevent coarsening of the texture under temperature fluctuations. Typical stabilizers are usually on or more hydrocolloids like locust bean gum, xanthan gum, carrageenan, agar, guar gum, and CMC (carboxymethylcellulose) or any other stabilizer mentioned herein. A suitable level of stabilizer may be around 0.2-0.3%. Emulsifiers, e.g. emulsifiers mentioned herein, may be used.

Production methods for ice cream is well known in the art and the skilled person will know how to prepare an ice cream mix, e.g. from ingredients mentioned herein. Ingredients of an ice cream mix may be blended by any suitable method, e.g. by agitation in a vat. If one or more ingredients are in the form of dry powders, mixing equipment especially constructed to mix dry powders into liquids may be used. Such equipment is well known in the art. High shear blending may be required to achieve adequate mixing of ingredients. If a separate fat phase is used, e.g. butter, anhydrous milk fat, butter oil, or vegetable oil, steps will usually be taken to ensure proper emulsification of the fat phase in the ice cream mix.

One or more ingredients of an ice cream mix according to the invention comprise phospholipids. Milk fat such as e.g. in the form of cream, cream powder, butter, or milk, comprises phospholipids. Also other dairy ingredients may comprise phospholipids, e.g. butter milk, butter milk powder, skim milk or skim milk powder. Non-dairy ingredients, e.g. lecithin or soy ingredients such as soy milk and soy lecithin, may also comprise phospholipids.

According to the method of the invention one or more ice cream mix ingredients are treated with a phospholipase. An ice cream mix ingredient to be treated may be treated separately; it may be mixed with one or more additional ingredients before treatment; or it may be mixed with all the other ingredients of the ice cream mix before treatment. An ice cream mix ingredient treated with a phospholipase may be mixed with additional ingredients of the ice cream mix after treatment with a phospholipase. An ice cream mix ingredient, or a composition of one or more ice cream mix ingredients, to be treated, comprises phospholipid. In one embodiment, the method of the invention takes place without any treatment with acyltransferase.

Phospholipids such as phosphoethanolamine and phosphatidylcholine consist of glycerol esterified with two fatty acids in an outer (sn-1) and the middle (sn-2) positions and esterified with phosphoric acid in the third position; the phosphoric acid, in turn, may be esterified to an amino-alcohol.

### Phospholipase

A phospholipase used in the process of the present invention includes phospholipase A₁, phospholipase A₂, phospholipase B, phospholipase C, and phospholipase D, and any combination thereof. In the process of the invention an ice cream ingredient is treated with a phospholipase, e.g. a single phospholipase; two or more phospholipases, e.g. two phospholipases, including, without limitation, treatment with both type A and B; both type A₁ and A₂; both type A₁ and B; both type A₂ and B; or treatment with two or more different phospholipases of the same type. Included is also treatment with one type of phospholipase, such as A₁, A₂, B, C, or D. In one embodiment an enzyme composition comprises phospholipase A₁, phospholipase A₂, phospholipase B, or any combination thereof.

The phospholipase activity may be provided by enzymes having other activities as well, such as e.g. a lipase with phospholipase activity. The phospholipase activity may e.g. be from a lipase with phospholipase side activity. In other embodiments of the invention the phospholipase enzyme activity is provided by an enzyme having essentially only phospholipase activity and wherein the phospholipase enzyme activity is not a side activity.

Phospholipase A₁ is defined according to standard enzyme EC-classification as EC 3.1.1.32.
Official Name: Phospholipase A₁.
Reaction catalyzed:
phosphatidylcholine+water <=>2-acylglycerophosphocholine+a fatty acid anion
Comment: has a much broader specificity than EC 3.1.1.4.

Phospholipase A₂ is defined according to standard enzyme EC-classification as EC 3.1.1.4
Official Name: phospholipase A₂.
Alternative Names: phosphatidylcholine 2-acylhydrolase.
lecithinase a; phosphatidase; or phosphatidolipase.
Reaction catalysed:
phosphatidylcholine+water <=>1-acylglycerophosphocholine+a fatty acid anion

Comment: also acts on phosphatidylethanolamine, choline plasmalogen and phosphatides, removing the fatty acid attached to the 2-position.

Phospholipase B is defined according to standard enzyme EC-classification as EC 3.1.1.5.
Official Name: lysophospholipase.
Alternative Names: lecithinase b; lysolecithinase;
phospholipase B; or PLB.
Reaction catalysed:
2-lysophosphatidylcholine+water< >glycerophosphocholine+a fatty acid anion

Phospholipase C is defined according to standard enzyme EC-classification as EC 3.1.4.3. Phospholipase C hydrolyses the phosphate bond of phosphatidylcholine and other glycerophospholipids, e.g. phosphatidylethanolamine, yielding diacylglycerol; this enzyme will also hydrolyse the phosphate bonds of sphingomyelin, cardiolipin, choline plasmalogen and ceramide phospholipids.
Reaction with phosphatidylcholine:
phosphatidylcholine+water <=>1,2-diacylglycerol+choline phosphate

Phospholipase D is defined according to standard enzyme EC-classification as EC 3.1.4.4. Phospholipase D hydrolyses the phosphate bonds of phospholipids and sphingomyelin to give the corresponding phosphatidic acid.

Reaction with phosphatidylcholine: A phosphatidylcholine+water <=>choline+a phosphatidate.

### Phospholipase A

Phospholipase A activity may be provided by enzymes having other activities as well, such as e.g. a lipase with phospholipase A activity. The phospholipase A activity may e.g. be from a lipase with phospholipase side activity. In other embodiments of the invention phospholipase A enzyme activity is provided by an enzyme having essentially only phospholipase A activity and wherein the phospholipase A enzyme activity is not a side activity.

Phospholipase A may be of any origin, e.g. of animal origin (such as, e.g. mammalian), e.g. from pancreas (e.g. bovine or porcine pancreas), or snake venom or bee venom. Alternatively, phospholipase A may be of microbial origin, e.g. from filamentous fungi, yeast or bacteria, such as the genus or species Aspergillus, e.g. A. niger; Dictyostelium, e.g. D. discoideum; Mucor, e.g. M. javanicus, M. mucedo, M. subtilissimus; Neurospora, e.g. N. crassa; Rhizomucor, e.g. R. pusillus; Rhizopus, e.g. R. arrhizus, R. japonicus, R. stolonifer; Sclerotinia, e.g. S. libertiana; Trichophyton, e.g. T. rubrum; Whetzelinia, e.g. W. sclerotiorum; Bacillus, e.g. B. megaterium, B. subtilis; Citrobacter, e.g. C. freundii; Enterobacter, e.g. E. aerogenes, E. cloacae Edwardsiella, E. tarda; Erwinia, e.g. E. herbicola; Escherichia, e.g. E. coli; Klebsiella, e.g. K. pneumoniae; Proteus, e.g. P. vulgaris; Providencia, e.g. P. stuartii; Salmonella, e.g. S. typhimurium; Serratia, e.g. S. liquefasciens, S. marcescens; Shigella, e.g. S. flexneri; Streptomyces, e.g. S. violaceoruber; Yersinia, e.g. Y. enterocolitica. Thus, phospholipase A may be fungal, e.g. from the class Pyrenomycetes, such as the genus Fusarium, such as a strain of F. culmorum, F. heterosporum, F. solani, or a strain of F. oxysporum. Phospholipase A may also be from a filamentous fungus strain within the genus Aspergillus, such as a strain of Aspergillus awamori, Aspergillus foetidus, Aspergillus japonicus, Aspergillus niger or Aspergillus oryzae. A preferred phospholipase A is derived from a strain of Fusarium, particularly F. venenatum or F. oxysporum, e.g. from strain DSM 2672 as described in WO 98/26057, especially described in claim 36 and SEQ ID NO. 2 of WO 98/26057. Another preferred phospholipase A is PLA2 from Streptomyces, such as e.g. PLA2 from S. violaceoruber. In further embodiments, the phospholipase is a phospholipase as disclosed in WO 00/32758 (Novozymes A/S, Denmark).

The activity of a phospholipase type A may e.g. be expressed in Lecitase Units (LEU). Phospholipase activity in Lecitase Units is measured relative to a phospholipase standard using lecithin as a substrate. Phospholipase A catalyzes the hydrolysis of lecithin to lyso-lecithin and a free fatty acid. The liberated fatty acid is titrated with 0.1 N sodium hydroxide under standard conditions (pH 8.00; 40.00° C.±0.5). The activity of phospholipase A is determined as the rate of sodium hydroxide consumption during neutralization of the fatty acid and is expressed in Lecitase units (LEU) relative to a Lecitase (phospholipase) standard (available from Novozymes A/S, Bagsvaerd, Denmark). 1 LEU is defined as the amount of enzyme that under standard conditions (pH 8.00; 40.00° C.±0.5) results in the same rate of sodium hydroxide consumption (μmol/min) as the Lecitase standard diluted to a nominal activity of 1 LEU/g.

### Phospholipase B

The term “phospholipase B” used herein in connection with an enzyme of the invention is intended to cover an enzyme with phospholipase B activity.

The phospholipase B activity may be provided by enzymes having other activities as well, such as e.g. a lipase with phospholipase B activity. The phospholipase B activity may e.g. be from a lipase with phospholipase B side activity. In other embodiments of the invention the phospholipase B enzyme activity is provided by an enzyme having essentially only phospholipase B activity and wherein the phospholipase B enzyme activity is not a side activity. In one embodiment of the invention, the phospholipase B is not a lipase having phospholipase B side activity as defined in WO 98/26057.

The phospholipase B may be of any origin, e.g. of animal origin (such as, e.g. mammalian), e.g. from liver (e.g. rat liver). Alternatively, the phospholipase B may be of microbial origin, e.g. from filamentous fungi, yeasts or bacteria, such as the genus or species Aspergillus, e.g. A. foetidus, A. fumigatus, A. nidulans, A. niger, A. oryzae; Botrytis, e.g. B. cinerea; Candida, e.g. C. albicans; Cryptococcus, e.g. C. neoformans, Escherichia, e.g. E. coli, Fusarium, e.g. F. sporotrichioides, F. venenatum, F. verticillioides; Hyphozyma; Kluyveromyces, e.g. K. lactis; Magnaporte, e.g. M. grisea; Metarhizium, e.g. M. anisopliae; Mycosphaerella, e.g. M. graminicola; Neurospora, e.g. N. crassa; Penicillium, e.g. P. notatum; Saccharomyces, e.g. S. cerevisiae; Schizosaccharomyces, e.g. S. pombe; Torulaspora, e.g. T. delbrueckii; Vibrio; e.g. V. cholerae. A preferred phospholipase B is derived from a strain of Aspergillus, particularly phospholipase LLPL-1 or LLPL-2 from A. niger, e.g. as contained in the Escherichia coli clones DSM 13003 or DSM 13004, or phospholipase LLPL-1 or LLPL-2 from A. oryzae, e.g. as contained in the E. coli clones DSM 13082 or DSM 13083 as described in WO 01/27251, especially described in claim 1 and SEQ ID NOs. 2, 4, 6 or 8 of WO 01/27251.

### Phospholipase C

The phospholipase C activity may be provided by enzymes having other activities as well, such as e.g. a lipase with phospholipase C activity or a phosphatase with phospholipase C activity The phospholipase C activity may e.g. be from a lipase with phospholipase C side activity. In other embodiments of the invention the phospholipase C enzyme activity is provided by an enzyme having essentially only phospholipase C activity and wherein the phospholipase C enzyme activity is not a side activity.

The phospholipase C may be of any origin, e.g. of animal origin, such as mammalian origin, of plant origin, or of microbial origin, such as fungal origin or bacterial origin, such as from a strain of Mycobacterium, e.g. M. tuberculosis or M. bovis; a strain of Bacillus, e.g. B. cereus; a strain of Clostridium, e.g. C. bifermentans, C. haemolyticum, C. novyi, C. sordellii, or C. perfringens; a strain of Listeria, e.g. L. monocytogenes; a strain of Pseudomonas, e.g. P. aeruginosa; or a strain of Staphylococcus, e.g. S. aureus; or a strain of Burkholderia, e.g. B. pseudomallei.

### Phospholipase D

The phospholipase D activity may be provided by enzymes having other activities as well, such as e.g. a lipase with phospholipase D activity, a phosphatase with phospholipase D activity, or a cholinesterase with phospholipase D activity. The phospholipase D activity may e.g. be from a lipase with phospholipase D side activity. In other embodiments of the invention the phospholipase D enzyme activity is provided by an enzyme having essentially only phospholipase D activity and wherein the phospholipase D enzyme activity is not a side activity.

The phospholipase D may be of any origin, e.g. of animal origin, such as mammalian origin, e.g. from mouse, rat, or Chinese hamster; of plant origin, e.g. from cabbage, maize, rice, castor bean, tobacco, cowpea, or Arabidopsis thaliana; or of microbial origin, such as of bacterial origin, e.g. from a strain of Corynebacterium, e.g. C. pseudotuberculosis, C. ulcerans, or C. haemolyticum; or fungal origin, such as e.g. from a strain of Streptomyces, e.g. S. antibioticus or S. chromofuscus; a strain of Trichoderma, e.g. T. reesei; a strain of Saccharomyces, e.g. S. cerevisiae; or a strain of Aspergillus, e.g. A. oryzae, A. niger, A. nidulans or A. fumigatus.

### Acyltransferase

Acyltransferase activity according to the invention is to be understood as the ability of an enzyme to transfer an acyl group from a lipid to one or more acceptor substances present in the ice cream mix or ice cream mix ingredient to be treated with an enzyme composition. A lipid according to the invention may e.g. be a phospholipid or a triglyceride. Acyltransferase activity is generally classified in the group EC 2.3.1 (Carboxy- and Carbamoyltransferase) according to the recommendations of the Nomenclature Committee of the International Union of Biochemistry and Molecular Biology (IUBMB). Acyltransferase activity according to the invention does not encompass phospholipase activity. Acyltransferase activity may be e.g. determined by the assays described in WO 2004/064537 A2 (Danisco A/S), e.g. the “Transferase assay in buffered substrate”, “Transferase assay in high water egg yolk” or the “Transferase assay in a low water environment”. These assays are suitable for determining transferase activity with cholesterol as the acyl acceptor. The skilled person may modify these assays to be used for determining acyl transferase activity with any lipid as acyl donor and any acyl acceptor.

### Enzyme Sources and Formulation

The phospholipase used in the process of the invention may be derived or obtainable from any of the sources mentioned herein. The term “derived” means in this context that the enzyme may have been isolated from an organism where it is present natively, i.e. the identity of the amino acid sequence of the enzyme are identical to a native enzyme. The term “derived” also means that the enzymes may have been produced recombinantly in a host organism, the recombinant produced enzyme having either an identity identical to a native enzyme or having a modified amino acid sequence, e.g. having one or more amino acids which are deleted, inserted and/or substituted, i.e. a recombinantly produced enzyme which is a mutant and/or a fragment of a native amino acid sequence. Within the meaning of a native enzyme are included natural variants. Furthermore, the term “derived” includes enzymes produced synthetically by e.g. peptide synthesis. The term “derived” also encompasses enzymes which have been modified e.g. by glycosylation, phosphorylation etc., whether in vivo or in vitro. The term “obtainable” in this context means that the enzyme has an amino acid sequence identical to a native enzyme. The term encompasses an enzyme that has been isolated from an organism where it is present natively, or one in which it has been expressed recombinantly in the same type of organism or another, or enzymes produced synthetically by e.g. peptide synthesis. With respect to recombinantly produced enzyme the terms “obtainable” and “derived” refers to the identity of the enzyme and not the identity of the host organism in which it is produced recombinantly.

Accordingly, the phospholipase may be obtained from a microorganism by use of any suitable technique. For instance, a phospholipase enzyme preparation may be obtained by fermentation of a suitable microorganism and subsequent isolation of a phospholipase preparation from the resulting fermented broth or microorganism by methods known in the art. The phospholipase may also be obtained by use of recombinant DNA techniques. Such method normally comprises cultivation of a host cell transformed with a recombinant DNA vector comprising a DNA sequence encoding the phospholipase in question and the DNA sequence being operationally linked with an appropriate expression signal such that it is capable of expressing the phospholipase in a culture medium under conditions permitting the expression of the enzyme and recovering the enzyme from the culture. The DNA sequence may also be incorporated into the genome of the host cell. The DNA sequence may be of genomic, cDNA or synthetic origin or any combinations of these, and may be isolated or synthesized in accordance with methods known in the art.

Suitable phospholipases are available commercially. Examples of enzymes for practical use are e.g. Lecitase® (Novozymes A/S, Bagsvaerd, Denmark) or YieldMAX® (Novozymes A/S, Bagsvaerd, Denmark and Chr. Hansen A/S, Hφrsholm, Denmark). A suitable phospholipase B is e.g. Aspergillus niger phospholipase LLPL-2 that can be produced recombinantly in A. niger as described in WO 01/27251.

In the process of the invention the phospholipase may be purified. The term “purified” as used herein covers phospholipase enzyme protein free from components from the organism from which it is derived. The term “purified” also covers phospholipase enzyme protein free from components from the native organism from which it is obtained, this is also termed “essentially pure” phospholipase and may be particularly relevant for phospholipases which are naturally occurring and which have not been modified genetically, such as by deletion, substitution or insertion of one or more amino acid residues.

Accordingly, the phospholipase may be purified, viz. only minor amounts of other proteins being present. The expression “other proteins” relate in particular to other enzymes. The term “purified” as used herein also refers to removal of other components, particularly other proteins and most particularly other enzymes present in the cell of origin of the phospholipase. The phospholipase may be “substantially pure”, i.e. free from other components from the organism in which it is produced, i.e., e.g., a host organism for recombinantly produced phospholipase. Preferably, the enzymes are at least 75% (w/w) pure, more preferably at least 80%, 85%, 90% or even at least 95% pure. In a still more preferred embodiment the phospholipase is an at least 98% pure enzyme protein preparation.

The terms “phospholipase” includes whatever auxiliary compounds that may be necessary for the catalytic activity of the enzyme, such as, e.g. an appropriate acceptor or cofactor, which may or may not be naturally present in the reaction system.

The phospholipase may be in any form suited for the use in question, such as e.g. in the form of a dry powder or granulate, a non-dusting granulate, a liquid, a stabilized liquid, or a protected enzyme. Granulates may be produced, e.g. as disclosed in U.S. Pat. No. 4,106,991 and U.S. Pat. No. 4,661,452, and may optionally be coated by methods known in the art. Liquid enzyme prepa-rations may, for instance, be stabilized by adding stabilizers such as a sugar, a sugar alcohol or another polyol, lactic acid or another organic acid according to established methods. Protected enzymes may be prepared according to the method disclosed in EP 238,216.

### Phospholipase Treatment

The phospholipase treatment of the invention is conducted under conditions sufficient to result in hydrolysis of at least 10% (weight/weight) of the phosphatidylcholine and/or 10% (weight/weight) of the phosphoethanolamine present in said one or more ice cream mix ingredients being treated with phospholipase. In one embodiment of the invention the phospholipase treatment is conducted under conditions sufficient to result in hydrolysis of at least 10% (weight/weight), such as at least 20%, at least 30%, at least 40%, at least 50% or at least 60%, of the phosphatidylcholine present in said one or more ice cream mix ingredients being treated with phospholipase. In another embodiment of the invention the phospholipase treatment is conducted under conditions sufficient to result in hydrolysis of at least 10% (weight/weight), such as at least 20%, at least 30%, at least 40%, at least 50% or at least 60%, of the phosphoethanolamine present in said one or more ice cream mix ingredients being treated with phospholipase. In yet another embodiment of the invention the phospholipase treatment is conducted under conditions sufficient to result in hydrolysis of at least 10% (weight/weight), such as at least 20%, at least 30%, at least 40%, at least 50% or at least 60%, of the total amount of phosphatidylcholine plus phosphoethanolamine present in said one or more ice cream mix ingredients being treated with phospholipase.

Suitable conditions under which to perform the treatment of phospholipase can be found by the skilled person by usual methods known in the art for optimising enzymatic reactions. The skilled person will know how to adjust parameters such as pH, temperature, and amount of phospholipase to achieve the desired results, taking into consideration the properties desired of the ice cream. The amount of phospholipase to be used in the method of the invention may depend on the activity of the specific phospholipase on the phospholipids present under the specific treatment conditions. When a phospholipase A is used the amount of phospholipase may e.g. be between 0.1 and 50 LEU per gram of fat, such as between 0.5 and 25, or between 1 and 10 LEU per gram of fat.

### Determination of Amount of Hydrolysed Phopsholipids

The amount of phospholipid that have been hydrolysed as a result of the phospholipase treatment may be determined by comparing the amount of phospholipid present before an after the treatment.

The amount of phosphatidylcholine and phosphoethanolamine may e.g. be determined by HPLC (High performance Liquid Chromatography) using the following method:

Lipid Extraction. Total milk lipids are extracted by mixing the sample with 1.2 ml of a 6% NaCl solution in water followed by 16 ml of chloroform/methanol (2:1). If cream is treated with phospholipase a suitable sample size is 4 grams. Samples are mixed vigorously for 5 min and centrifuged at 3000 rpm for 5 min. 8 ml of the lower CHCl₃ phase is removed. The above mentioned extraction procedure is repeated and the combined organic extract (2×8 millilitres) are dried down under vacuum. Samples are reconstituted in 5 ml of CHCl₃. Phospholipids are further purified by solid phase extraction (SPE). The column is washed first with 4 ml of chloroform/isopropanol (2:1) to remove neutral lipids and then with 4 ml of diethylether acidified with glacial acetic acid (2% v/v) to remove free fatty acids. Phospholipids are then eluted with 4 ml of methanol, dried down in a rotary evaporator, and reconstituted in 0.6 ml of mobile phase A for HPLC analysis.

HPLC Method. The stationary phase may be of a Luna Silica (150×4.6 mm, 5 micron, 100 A) analytical column and a Security Guard Cartridge (4.0×3.0 mm) consisting of the same packing material. Both analytical and guard columns are produced by Phenomenex (Torrance, Calif. USA). The mobile phases are an A mixture containing 80% chloroform, 19.5% methanol, 0.5% ammonium hydroxide and a B mixture of 60% chloroform, 34% methanol, 5.5% water, 0.5% ammonium hydroxide. The following linear gradient is utilized: a starting composition of 80% A/20% B is held for 2 min, proceeding to 100% B from 2 min to 14 min; 100% B is maintained from 14 min to 20 min, returning to 80% A/20% B from 20 min to 23 min. The time required to re-equilibrate the column in a sequence of runs is 7 min. Phospholipid standards consisiting of highly pure phosphatidylethanolamine (PE) and phosphatidylcholine (PC) are used, e.g. from Avanti Polar Lipids, Inc. Stock solutions are prepared in chloroform in the concentration range of 2-10 mg/ml. HPLC calibrators are prepared from phospholipid stock solutions by dilution to the appropriate concentration in mobile phase A. Detection is performed by light scattering.

Quantitative Analysis of phospholipids. Standard curves with a suitable dynamic mass range, e.g. of 2.5 to 12 μg of PE and PC are constructed on the HPLC. Controls and test samples are analyzed in duplicate. The masses of PE and PC of control and test samples are predicted from the appropriate standard curve by non-linear regression analysis using a 2nd order polynomial model. The extent of phospholipid depletion in test samples is calculated by comparing the mass of PE and PC to those found in the untreated control sample.

### Production of Ice Cream

According to the method of the invention an ice cream mix is produced by a) treating one or more ice cream mix ingredients with a phospholipase; and b) producing an ice cream mix with the one or more treated ingredients of step a); wherein step a) is conducted before, after or during step b).

The ice cream mix produced by the method of the invention may be frozen to produce ice cream. Freezing may be performed by any method suitable to produce ice cream with the desired properties. Methods for freezing ice cream mix to produce ice cream are well known in the art.

Before freezing an ice cream mix it may be pasteurised to reduce the number of microorganisms. Pasteurisation may e.g. be performed as batch pasteurisation in a tank or vat, e.g. at 69° C. for 30 minutes, or as continuous pasteurisation, e.g. in a plate heat exchanger, e.g. at 80° C. for 25 seconds. The ice cream mix may also be homogenised before freezing to reduce the size of fat globules and/or to improve dissolution and/or emulsification of ingredients. Further, the ice cream mix may be aged before freezing to ensure fat crystallisation, protein and stabiliser hydration, and/or membrane rearrangement and emulsifier/protein interaction is completed before freezing. Ageing is usually conducted by keeping the mix at low temperature, e.g. 2-5° C., for e.g. 4-24 hours before freezing. Liquid flavours, fruit purees and/or colours will usually be added after pasteurisation, homogenisation and ageing, if these steps are performed.

The ice cream mix may be frozen by any method known in the art. Usually, the ice cream mix will be stirred during freezing to prevent the formation of large ice crystals, and may also be whipped to incorporate air into the ice cream mix. Usually, about 20-50% air (volume/volume) is incorporated into the ice cream mix during freezing. Freezing and whipping may e.g. be performed in a continuous barrel freezer, a tubular scraped-surface heat exchanger. If a barrel freezer is used, the ice cream will normally have about 50% of the water frozen when leaving the freezer and have a soft texture. It may be served directly as soft-serve ice cream. Particulate ingredients, e.g. nuts, almonds, pieces of chocolate, pieces of fruit, or berries, may be added to the soft frozen ice cream. If hard-frozen ice cream is desired, the soft-frozen ice cream may e.g. be filled into containers, cones, moulds, wafers, or any desired packaging and subjected to hardening. Hardening usually takes place in a freezer at a temperature between −20° C. and -40° C., often with high speed air fans to increase the rate of freezing, so the temperature is quickly lowered, often to below −20° C. If the soft frozen ice cream has been extruded into moulds, they may be hardened by immersion of the moulds into cold liquid, e.g. calcium chloride solution, and removed from the moulds and packed when hardening is complete. After hardening the ice cream may be stored until consumption. If prolonged storage is required the storage temperature is usually kept at −25° C. or below.

In a further embodiment the invention relates to use of an enzyme preparation comprising a phospholipase and free from acyltransferase activity for producing an ice cream product. In a still further embodiment the invention relates to an ice cream product obtainable by, or obtained by, the method of the invention.

### EXAMPLES

### Example 1

Ice cream mix with 8% fat was produced with following composition:

| Raw material | Amount, kg |
|---|---|
| Water | 21.440 |
| Cream 38% fat | 8.400 |
| Sucrose | 4.600 |
| Glucose | 1.360 |
| Skim milk powder | 3.200 |
| Butter milk powder | 1.000 |

The ingredients were mixed at temperature 75° C. for 10 minutes, cooled to 35° C. and divided into two batches.

Phospholipase (YieldMAX PL, a fungal phospholipase A₁, Chr. Hansen A/S and Novozymes A/S, Denmark; dosage 40 LEU/I ice cream mix) was added to one batch of ice cream mix and the batch was held for 30 minutes at 35° C., pasteurized at 85° C. for 20 seconds, and homogenized at 175 bar. The ice cream mix was then cooled to 5° C. and held for 20 hours at 5° C. (ageing) before freezing. Freezing with 102% overrun and exit temperature from freezer of −5° C. The ice was packed in 115 ml beakers, closed and stored at −18° C. until sensory evaluation.

The other batch (control) was treated the same way except no phospholipase was added.

### Sensory Analysis

Triangle test was used to detect differences between the two batches. The ice cream samples were removed from the freezer 10 minutes before evaluations. Nine assessors attended the session. The assessors where presented with three samples in each session, two samples from one batch of ice cream and one from the other batch of ice cream, and where asked to identify the sample differing from the two others. The assessors were asked to write down comments on how differences were perceived. Each assessor evaluated two triangle tests (two sessions). The results were evaluated as described in “Sensory Evaluation Techniques”, table T7 page 338 in Meligaard, M., Civille, G. V. & Carr, B. T., 1991. Sensory Evaluation Techniques, 2nd edition. CRC Press Inc., Florida.

Table 2 shows the results of the triangle tests.

TABLE 2
Results from triangle tests

| | Number of | Number of | Significance |
|---|---|---|---|
| | assessors | correct answers | level |
| Session 1 | 9 | 6 | 5% |
| Session 2 | 9 | 7 | 1% |

It appears from Table 2 that significant differences were found between the reference and PL-treated ice cream in both tests.

The assessors were asked to describe how differences between the samples were perceived. The descriptions (for right answers) can be summed up as:

### Control Batch of Ice Cream:

melts faster
more soft
less sweet
less creamy
off-flavour; cardboard

### Phospholipase Treated Batch of Ice Cream:

more creamy/cream flavour
more hard, firm
less but more coarse crystals

The phospholipase treatment of the ice cream mix had a significant effect on both texture and flavour, as the phospholipase treated ice cream had more cream flavour and more sweet taste, the texture was more hard/firm and less crystallized. The control ice cream melted faster in the mouth and was softer.

1. A method for producing an ice cream mix comprising:
a) treating one or more ice cream mix ingredients with a phospholipase under conditions sufficient to result in hydrolysis of at least 10% (weight/weight) of the phosphatidylcholine and/or 10% (weight/weight) of the phosphoethanolamine; and
b) producing an ice cream mix with the one or more ingredients treated in step a);
wherein step a) is conducted before, after or during step b).

2. A method for producing an ice cream comprising:
a) producing an ice cream mix by the method of claim 1; and
b) freezing the ice cream mix to produce ice cream.

3. The method of claim 1 wherein the phospholipase is selected among Phospholipase A1, Phospholipase A2, Phospholipase B, and any combination thereof.

4. The method of claim 1 further comprising heating the phospholipase treated ice cream mix or ice cream mix ingredient at a temperature and time sufficient to inactivate the phospholipase.

5. The method of claim 1 wherein the phospholipase is purified.

6. The method of claim 1 wherein the one or more ice cream mix ingredients to be treated with a phospholipase comprises one or more dairy ingredients.

7. The method of claim 6 wherein the one or more dairy ingredients to be treated with a phospholipase comprises milk fat.

8. The method of 1 wherein the one or more ice cream mix ingredients to be treated with a phospholipase comprises one or more ingredients derived from soy.

9. The method of claim 8 wherein the one or more soy derived ingredients to be treated with a phospholipase comprises one or more of soy milk, soy protein isolate, soy protein concentrate, soy lecithin, and soy oil.

10. The method of claim 8 wherein the ice cream produced is soy ice cream.

11. The method of claim 1 wherein no treatment with acyltransferase takes place.

12. (canceled)

13. An ice cream product obtainable by the method of claim 1.
